(19) United States
(12) Patent Application Publication
(10) Pub. No.: US 2003/0062785 A1
(43) Pub. Date: Apr. 3, 2003

(54) MagnoDrive

(76) Inventor: Ramesh S. Vasudevan, Austin, TX (US)

Correspondence Address: Ramesh S. Vasudevan, 2205, South 142nd Court, APT#5, Omaha, NE, 68144, US

(21) Appl. No.: 09/970,277

(22) Filed: Oct. 3, 2001

(51) Int. Cl. H02K 21/00; H02K 15/02

(52) U.S. Cl. 310/152; 29/598; 29/607

(57) ABSTRACT

The MagnoDrive is a drive developed to generate mechanical torque/mechanical power output as an electric motor does. This uses the magnetic field reaction to produce the rotational motion without any external power input. In a way, it extracts the magnetic energy from the environment (or uses internal stored energy of the magnet) to produce the power output. This uses reaction of the magnetic fields of permanent magnets to produce rotational motion. This is linearly scalable to meet high power demand, by constructing many stages on single shaft as a Multistage MagnoDrive. This can be coupled directly to any mechanical system or to a generator to get electric power output. Electric powered MagnoDrive works on the same principle as a MagnoDrive except, the permanent magnets are replaced with electro magnets. This is pollution free, cost free energy supply source, aimed to serve every one everywhere.

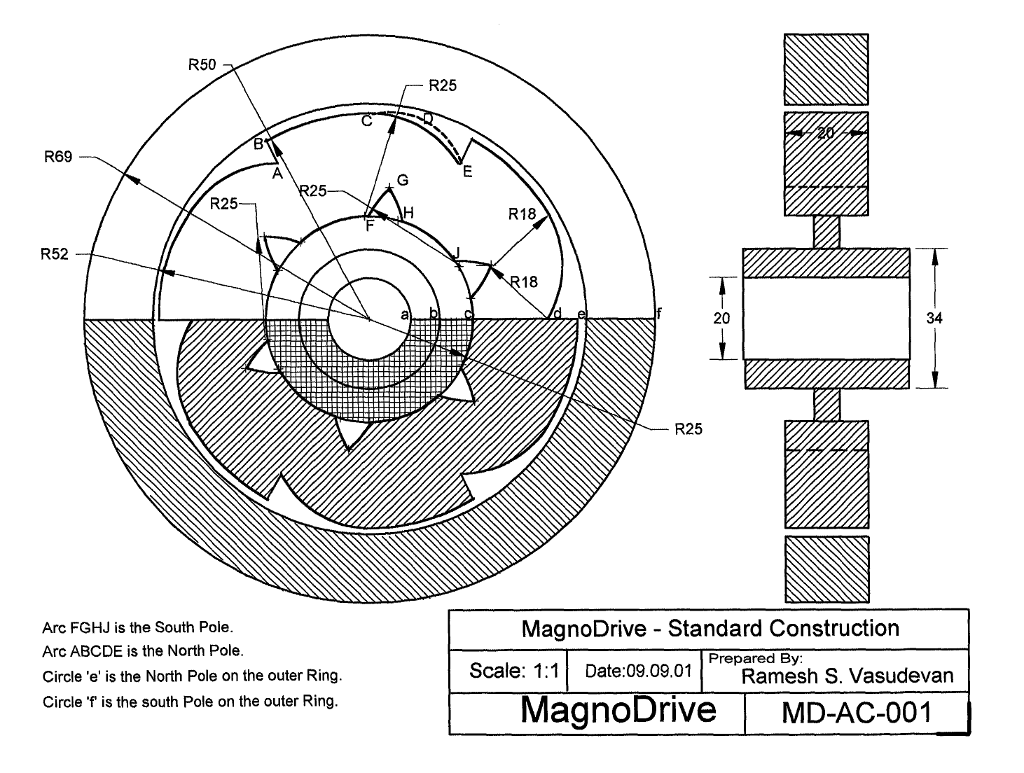

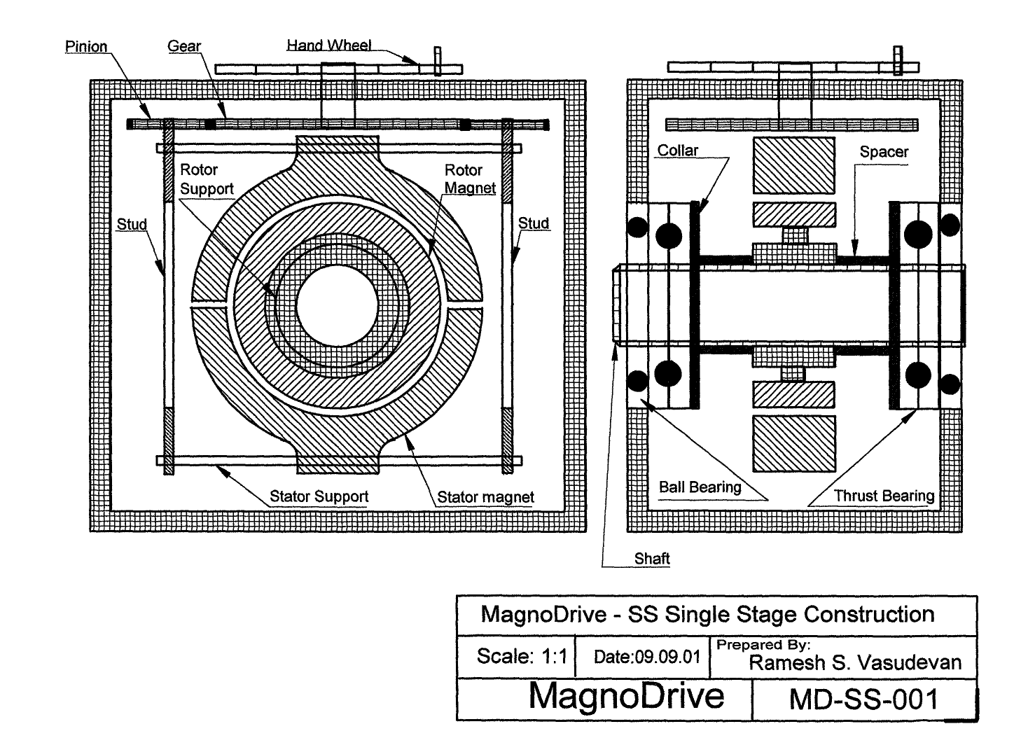

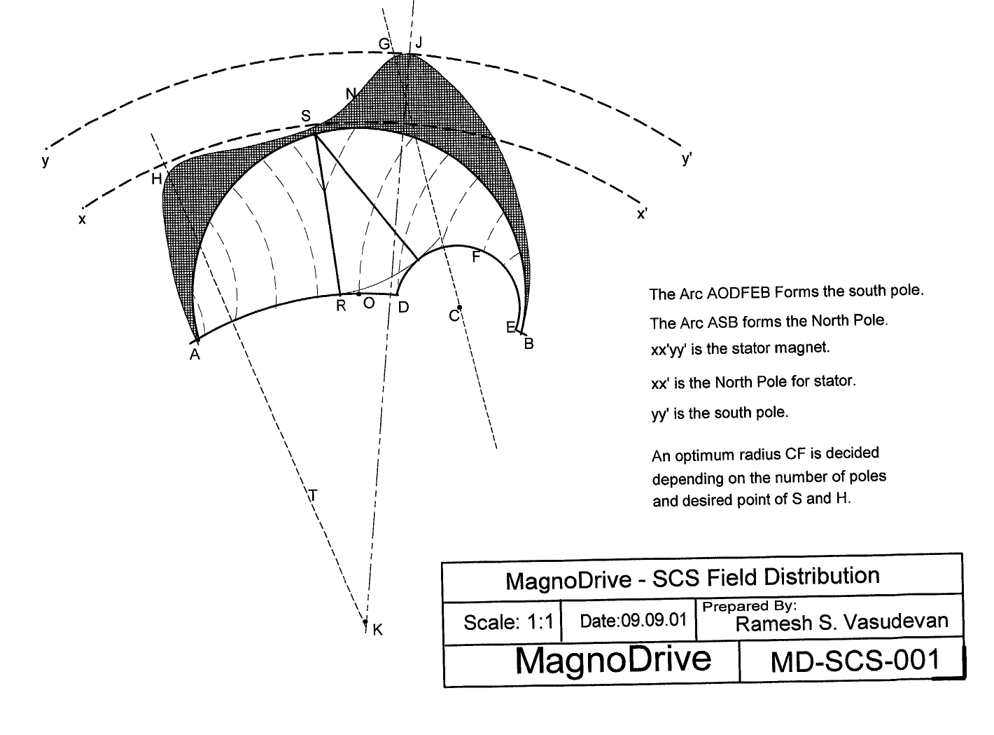

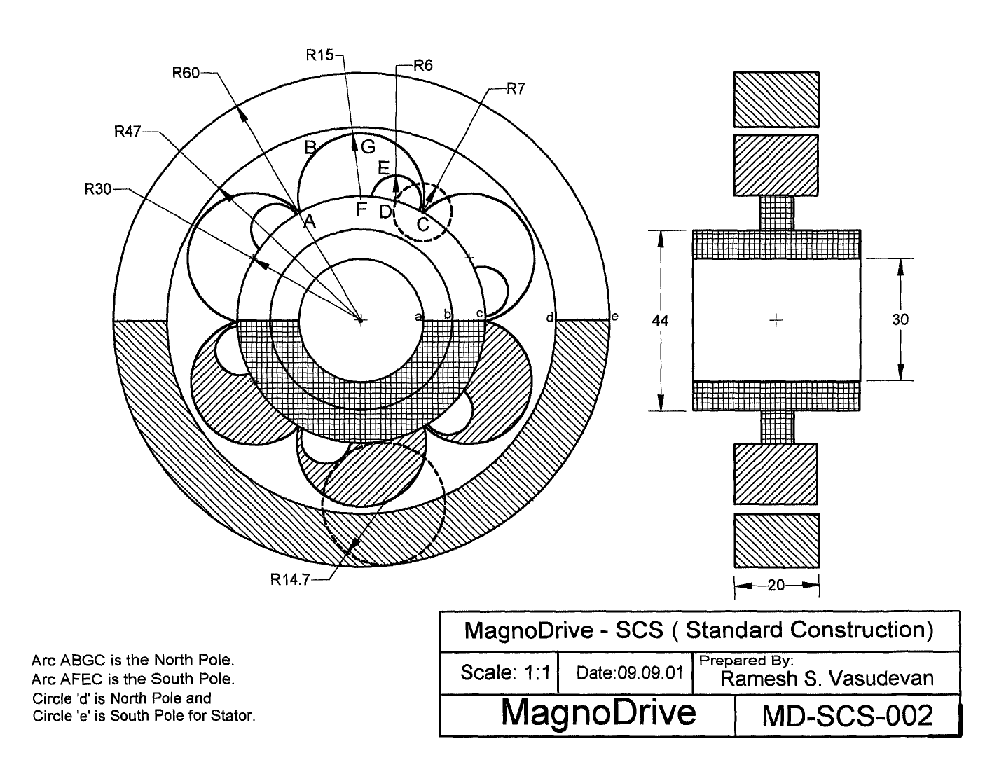

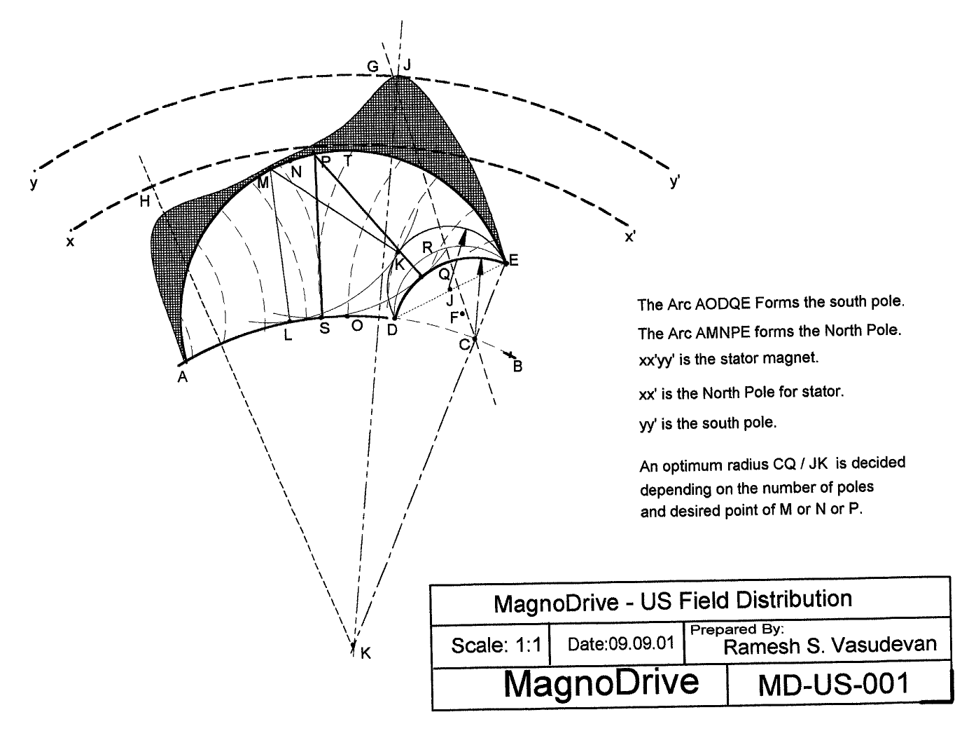

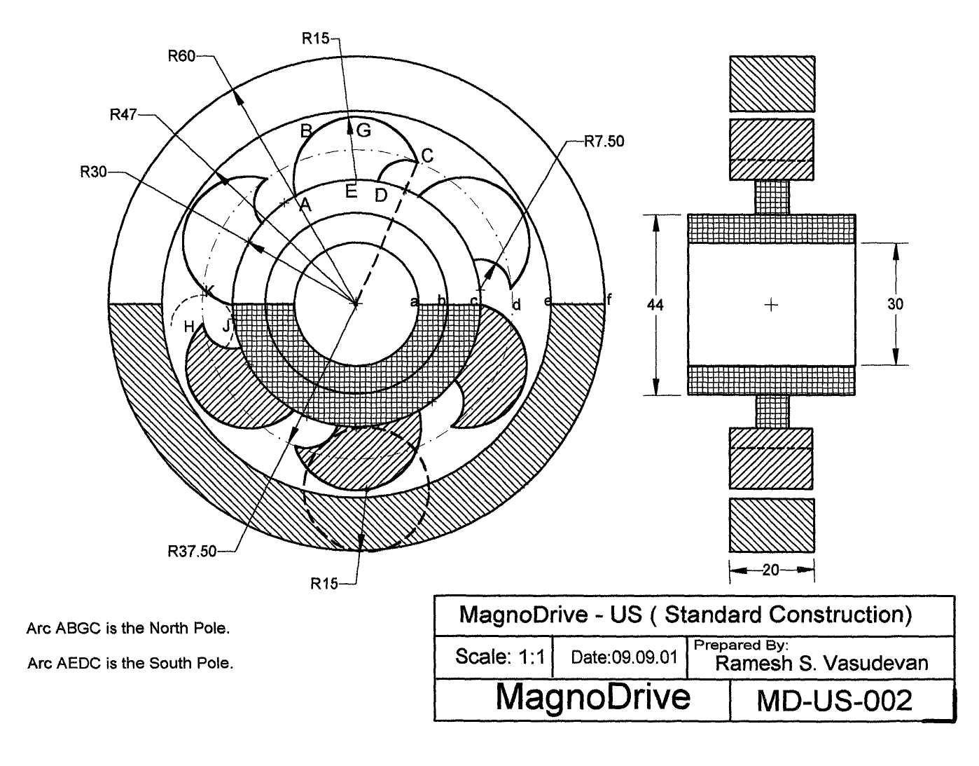

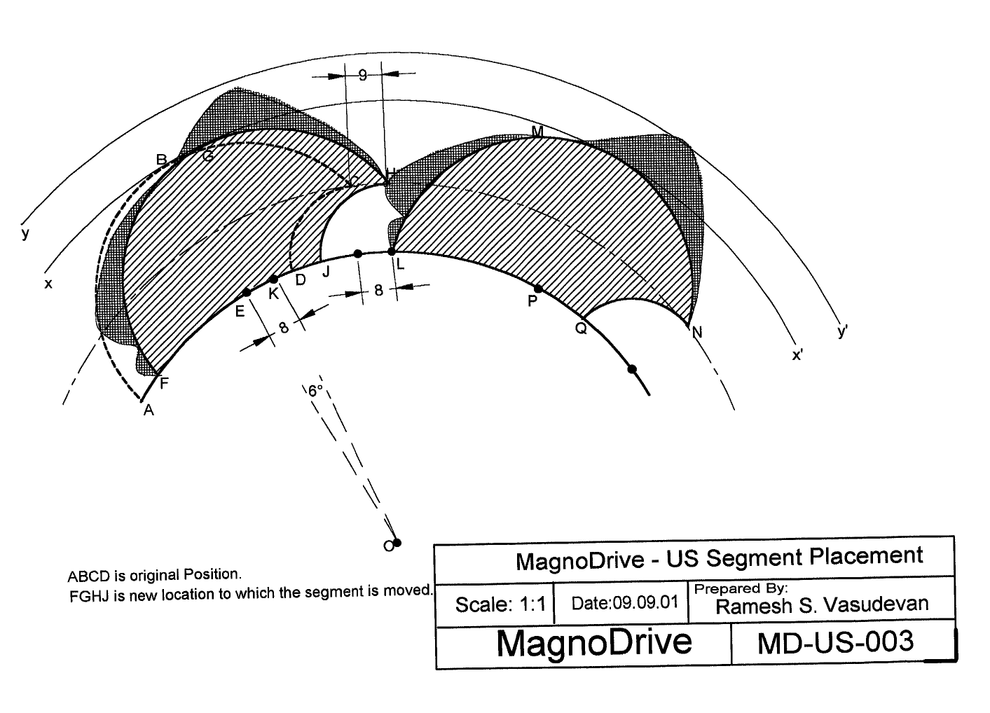

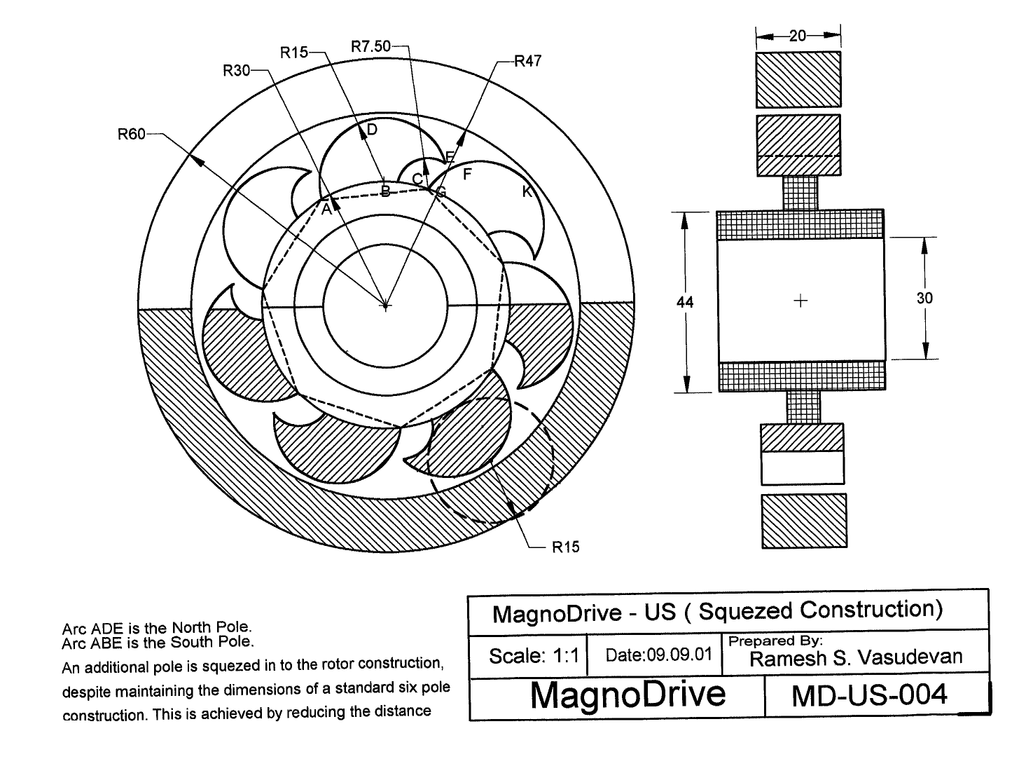

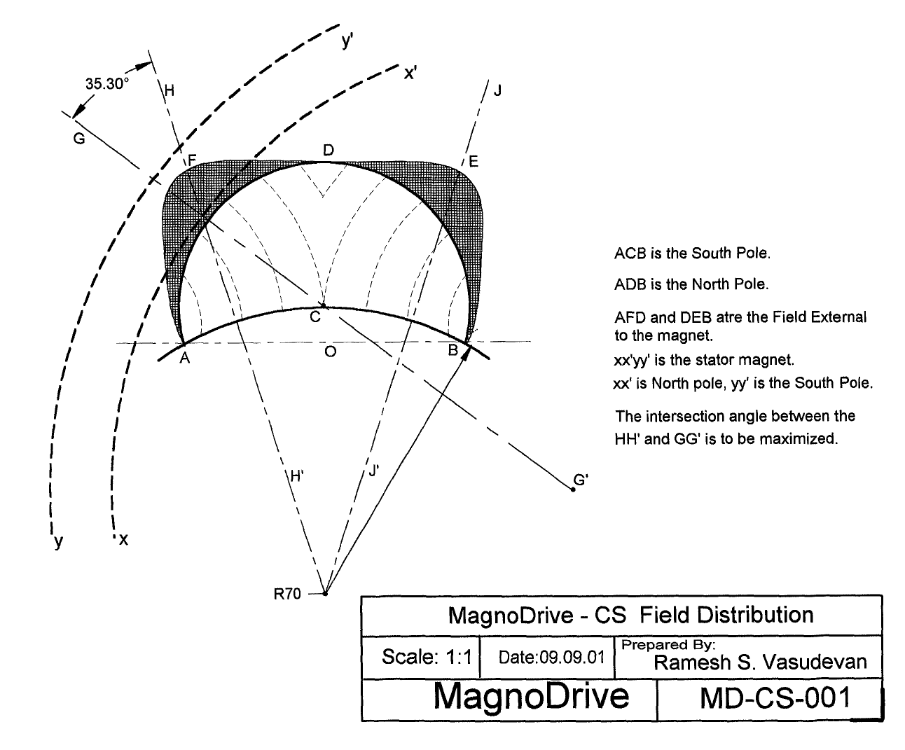

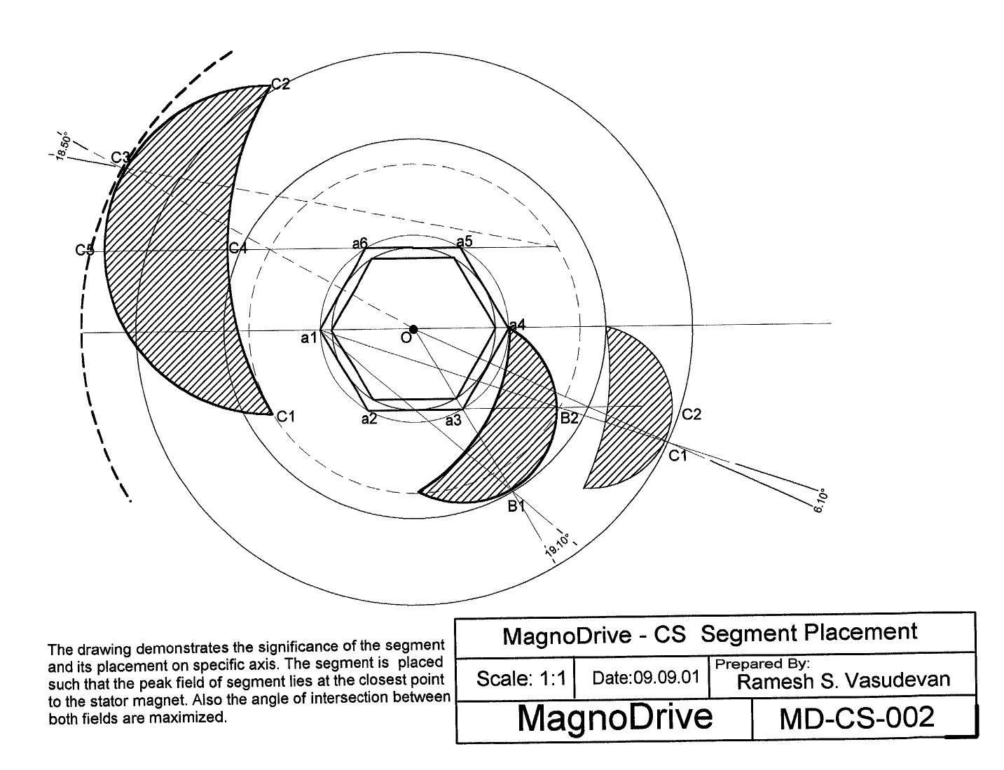

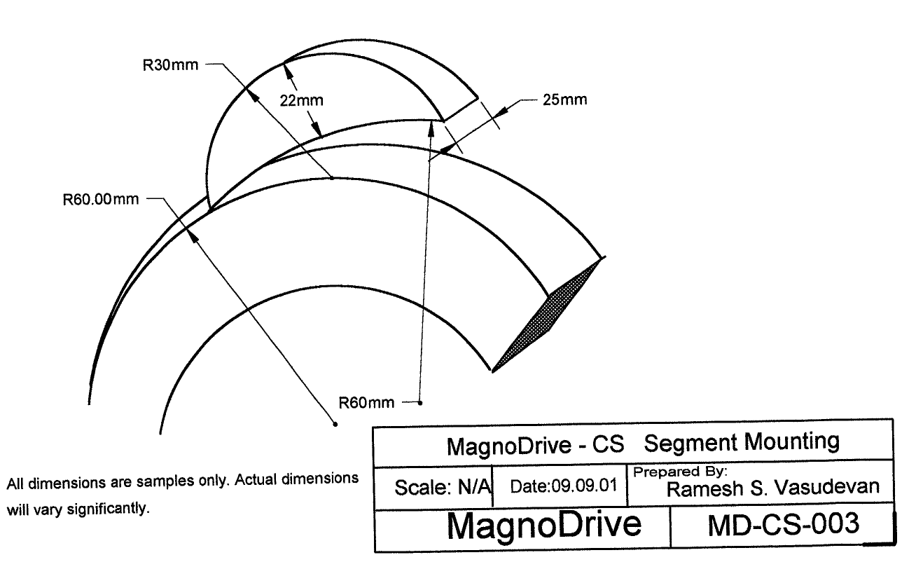

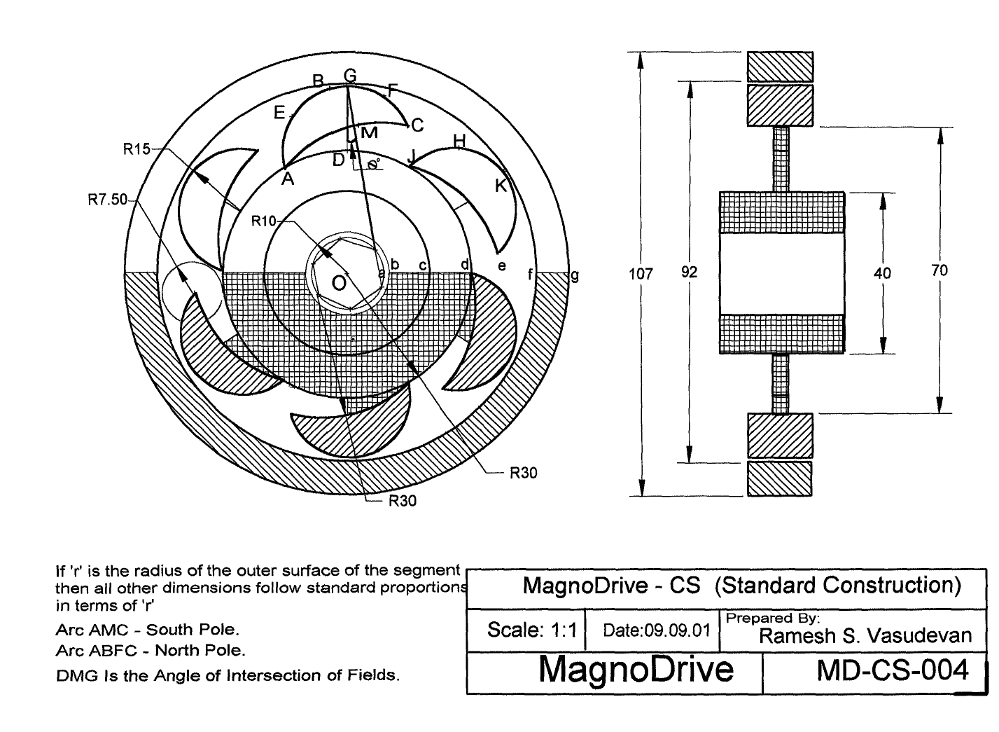

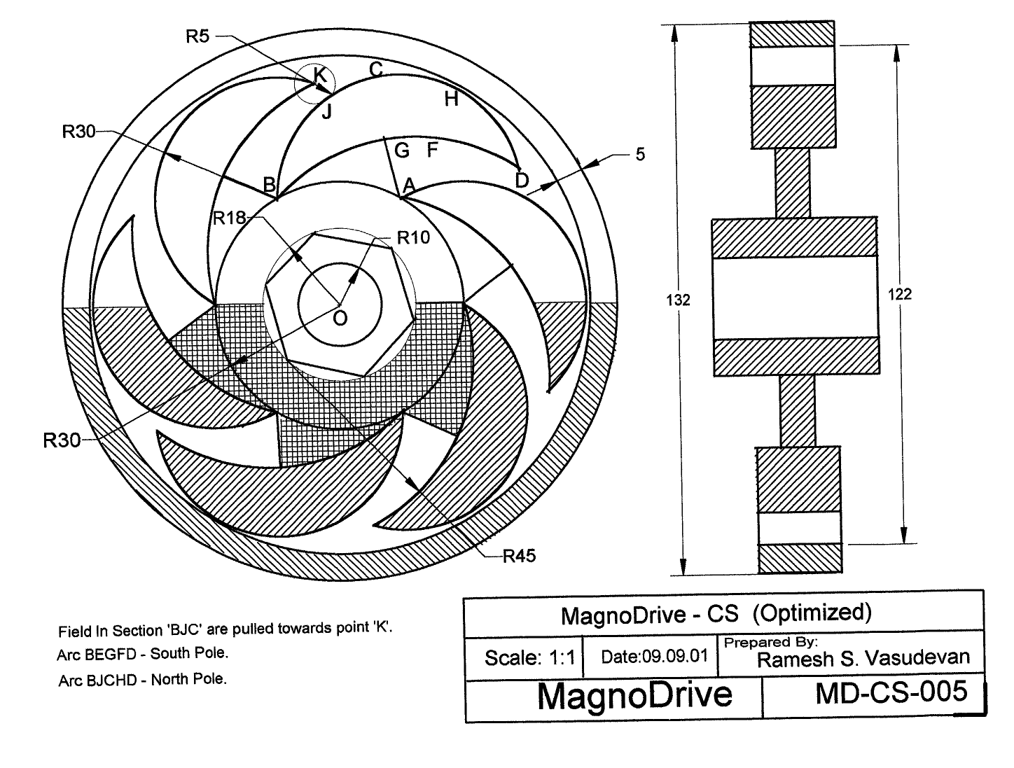

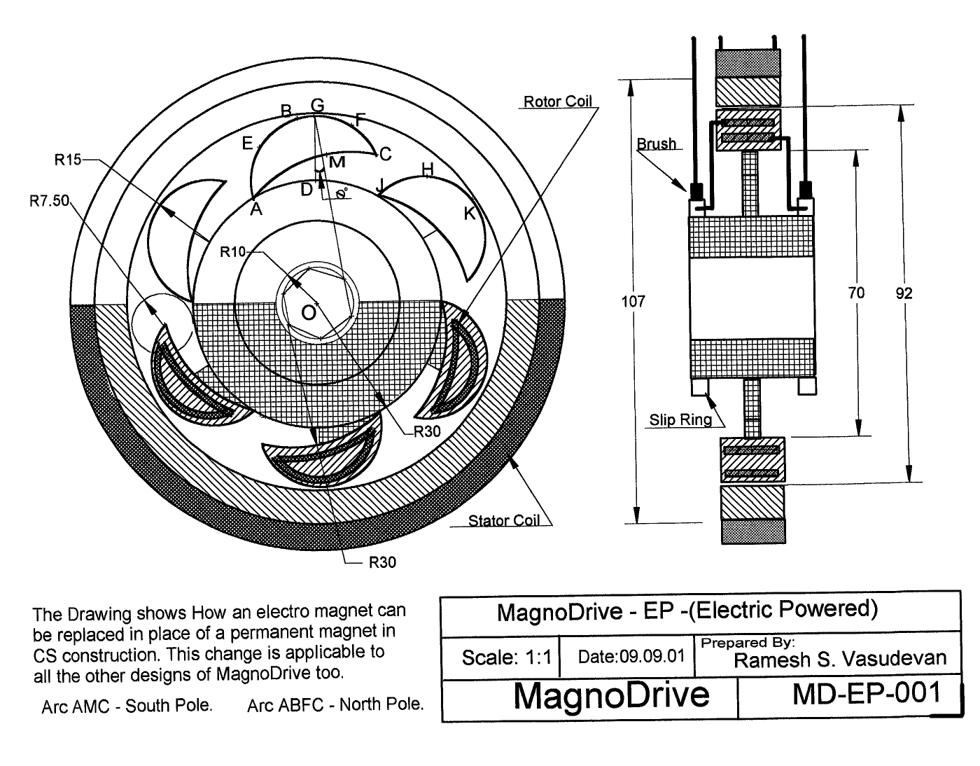

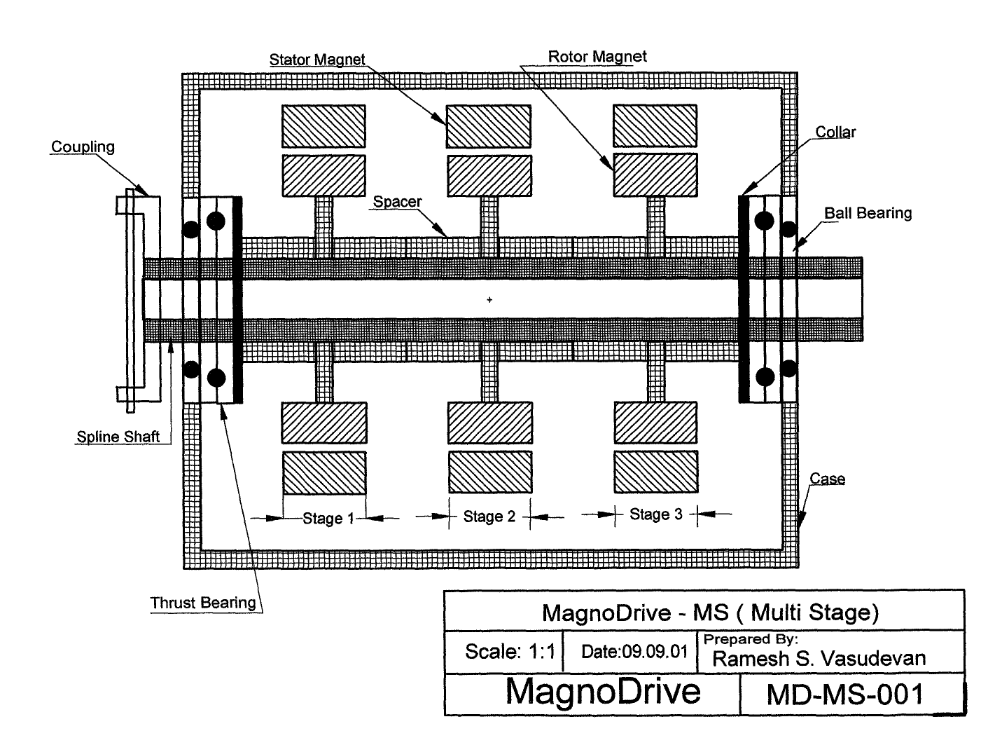

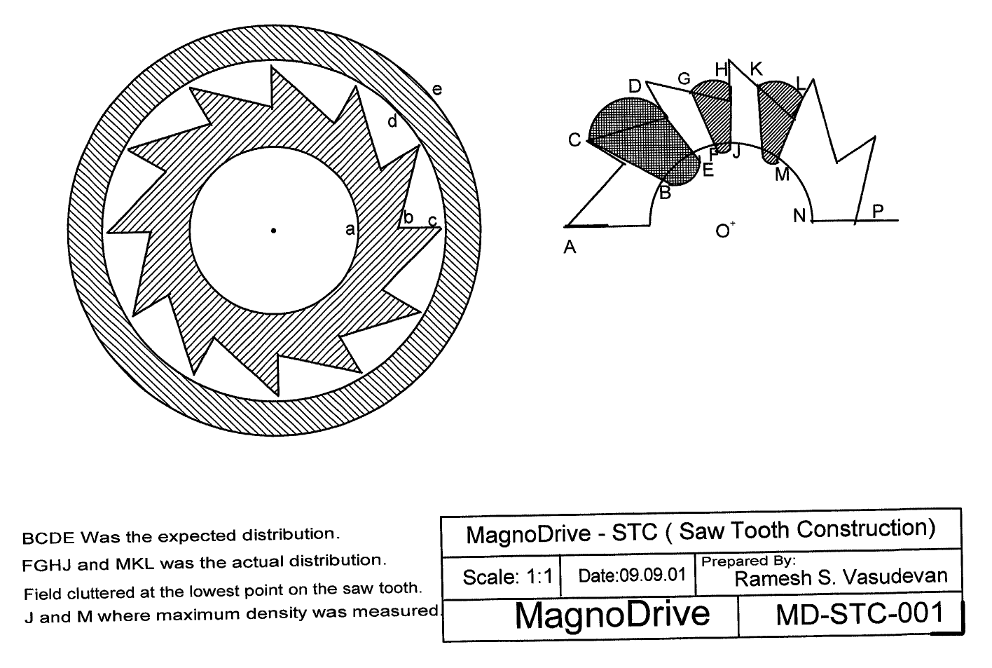

### CROSS REFERENCE TO RELATED APPLICATION

NOT APPLICABLE.

### STATEMENT REGARDING FEDERALLY SPONSERED R & D NOT APPLICABLE.

It is a solo development. I developed this product without any government or individual support.

### REFERENCE TO SEQUENCE LISTING, A TABLE or A COMPUTER PROGRAM LISTING APPENDIX.

NOT APPLICABLE.

### BACKGROUND OF INVENTION

The MagnoDrive is a Motor, which is equivalent to an electric motor. This works purely due to magnetic field reaction using permanent magnets. This doesn't require any external power input. The repulsive force of the magnet is used to produce the turning moment. This contains a stator cylindrical magnet with uniform field distribution as in a cylindrical magnet. The rotor assembly is with a specific design. Changing the shape of the magnet changes the field distribution of the rotor magnets. The rotor magnets field is peaked with reference to a point followed by a fall in field density. By assembling the magnets over a rotor surface in a specific way, an essential condition is met there by we get continuous reaction. The magnetic field density difference at the reaction point between the stator and rotor magnetic fields and the intersection angle of the fields decide the torque, and the power output. The construction methods are well explained in the following sections. The electric powered MagnoDrive is an exception, where it would replace the permanent magnet with electro magnet, so it requires an electric power to be supplied.

Clasification

This may be classified as a Motor in the field of Electrical Engineering.

This may be classified as a Non Electric Motor using Magnetism, which will be entirely a new field.

This may be classified as a Magnetic power drive.

This may be classified as a Magnetic energy extractor.

Principles and Properties Considered

Magnetic lines of forces inherently have the following properties:

1. The magnetic lines of force take the least reluctance path. When the medium external to the magnet is same, the distance decides the field strength and direction.

2. The lines of force don't cross each other. They always travel in straight line or in a curved path close to the magnet.

3. Like pole fields repel each other. If, repulsive force is equal in all direction, then it stays tight in place. Essentially, the resultant force and its direction decide the Force and direction of the Field.

4. There is always one entry point and one exit point for every magnet. These are termed as North Pole and South Pole.

5. The magnetic lines of forces always emanate perpendicular to its surface at the pole face. Apart from these properties, the magnetic repulsion is perennial. These forces continue, as long as the material retains its magnetic property

Little Experiment with a DC Motor

Take a small toy motor. This contains a pair of permanent magnets and a rotor with small armature and coils arranged in proper order. The two permanent magnets are substitute for the field coil of a regular high power DC motor. However, functionally, the high power motor and the toy motor are same. When a DC power is supplied to the armature through brush, it rotates. Suppose, if you remove one permanent magnet piece from its place, For example, say the South Pole facing the armature is removed, still it works and with some reduced power. This has been tested, and it promises that, motor works with like pole reaction only. Basically it needs a repulsive field followed by a dead pocket, a non-reactive space for it to deflect. It is not mandatory to have the rotor placed between the North Pole and South Pole.

### BRIEF SUMMARY OF INVENTION

Using the principle discussed in the background of the invention,

It is possible to get a continuous magnetic field using the permanent magnet.

It is possible to change the field distribution by changing the shape of the magnet.

It is possible to control the magnetic field reaction by moving it close or away to another magnet.

It is possible to make the desired reaction by using construction technique. Using all these techniques, I managed to make a useful motor, which can develop torque without any external input. This uses a pair of permanent magnets, one for stator and another for rotor. The stator is made up of a cylindrical magnet with the North Pole on the inner face and the South Pole on the outer surface. The stator is a smooth cylindrical piece. In order to have a controlled reaction, I sliced the stator cylindrical magnet into two pieces. Moving them towards rotor will increase the reaction between stator and rotor fields and moving it away reduces the magnetic reaction. That is how I control the motor.

The rotor assembly can be constructed using different shapes of magnet. The rotor shaft has a definite size, and is of cylindrical shape. The magnet pieces are assembled over the rotor. The choice of the magnet decides the field direction, strength and distribution. However, the field distribution is chosen such that, it always peaks at one place on the surface, with field at an angle to the surface, followed by a fall in field strength. By assembling it in an appropriate direction with proper displacement, the rotor is made to react with stator field and rotate. The construction methods of different styles are described clearly in the following sections.

Electric powered MagnoDrive uses electro magnets instead of permanent magnets. The field distribution should remain same irrespective of the coil. Hence coils should preferably be encapsulated with solid magnetic piece. The other alternate is to use coils only for the stator piece and use permanent magnets for the rotor pieces.

Since the height and thickness of rotor magnet are limited, the power output will be limited with single stage. A Multi stage MagnoDrive is built by assembling many sets on the same shaft to increase the power output with proper displacement between stages. This would envisage capacity to meet a higher demand of power from a single source.

Since construction demands higher precision, proper displacement, right assembly technique, Please refer to the detailed description of the construction of the drives. Each rotor assembly varies significantly.

In all of the construction, the rotor assembly is such that, the outer most surface of the rotor would stick to a circular path inside the stator. The thickness, width and clearances are maintained according to the choice of the rotor magnet. The Field distribution and clearances plays a vital role in the success of the product. The width of the stator magnet and rotor magnet are to be maintained same and should have perfect alignment. Failing which, rotor will exert huge axial thrust. Similarly, the width and the thickness are to be maintained same to retain expected distribution.

Irrespective of the choice of one of the few explained rotor assembly, the principles used in single stage construction, Multi stage construction and electric powered MagnoDrive are applicable to all. There is no limitation on the number of poles. The size of the rotor radius, pole width and required clearance decides the number of poles. The model is linearly scalable. However, the ratios are to be maintained.

### LIST OF DRAWINGS

1. MD-AC-001 MagnoDrive Standard Construction.

The Arc Construction method of building the MagnoDrive is shown in this drawing. This is the standard method to build the MagnoDrive Rotor.

2. MD-SS-001 MagnoDrive—SS Single Stage

This drawing shows the suggested assembly method of building a single stage MagnoDrive (motor). Irrespective of the choice of the rotor assembly and different types of the magnet segments, this is the applicable method for building a single stage MagnoDrive.

3. MD-SCS-001 MagnoDrive—SCS Field Distribution.

This drawing shows the field distribution in a semicircular segment.

4. MD-SCS-002 MagnoDrive—SCS Standard Construction.

This drawing shows the rotor assembly and construction of MagnoDrive using the semi circular segment magnet.

5. MD-US-001 MagnoDrive—US Field Distribution.

This drawing shows the field distribution in an umbrella segment.

6. MD-US-002 MagnoDrive—US Standard Construction.

This drawing shows the construction of rotor assembly using umbrella segment magnets. This also shows the standard construction of the MagnoDrive-US.

7. MD-US-003 MagnoDrive—US Segment Placement.

This drawing shows the influence of the placement of umbrella segment and effects of altering the distance between segments.

8. MD-US-004 MagnoDrive—US Squeezed Construction.

This drawing shows the advantage of altering the distance between segments and shows a seven pole construction using umbrella segment by changing the distance between the poles.

9. MD-CS-001 MagnoDrive—CS Field Distribution.

This drawing shows the distribution of the field in a crescent segment.

10. MD-CS-002 MagnoDrive—CS Segment Placement.

This drawing shows the influence of the placement of the segments and choosing advantageous location to place the segment magnets.

11. MD-CS-003 MagnoDrive—CS Segment Mounting.

This drawing shows the three-dimensional view of the Magnet segment assembly over a rotor base.

12. MD-CS-004 MagnoDrive—CS Standard Construction.

This drawing shows the standard method building a rotor assembly using the crescent segment and building the MagnoDrive using crescent segment.

13. MD-CS-005 MagnoDrive—CS Optimized Construction.

This drawing shows the advantageous selection of crescent segment and building a rotor assembly with crescent segment and optimizing the MagnoDrive with Crescent segment.

14. MD-EP-001 MagnoDrive—EP Electric Powered

This drawing shows the construction method of MagnoDrive using electro magnets instead of permanent magnets.

15. MD-MS-001 MagnoDrive—MS Multi Stage

This drawing shows the construction method of multistage MagnoDrive to meet high power demand from a single source.

16. MD-STC-001 MagnoDrive—STC Saw Tooth Construction

This drawing shows the method of construction the saw tooth construction of MagnoDrive. This drawing is attached, as the result of this method is important and formed basis for other construction methods.

### DETAILED DESCRIPTION

Magnodrive

Base Model—Arc Construction with Offset Slot

Reference Drawing: MD-AC-001

This is the basic model of the MagnoDrive construction. The drawing shows the construction method. The outer stator magnet is as usual, a smooth cylindrical magnet. The rotor shown in the figure is a six poles construction. Depending on the height of the magnet and rotor diameter the number of poles can be increased or decreased.

To start with, the base rotor is cylindrical shape. From the outer surface the material is carved out as shown in the figure. While BC segment lies on the circumference of the circle with radius 50, the portion CE lies on the circle with circumference of the circle with center F and radius FC=25. This arc CE meets the axis OJ at point E. This fixes the lowest point on the outer surface. Now the peak point on the surface is all the points on section BC.

Please refer the drawing of the Saw tooth construction of rotor MD-STC-001, added to the end of the document. Though this construction method was abandoned, this gave me an important result. Based on that result only, I arrived at these new construction methods.

From the Saw tooth Construction we got the result that the field will clutter at the lowest point. Without the slot FGH, the E is the lowest point. To move the field density from E to some where between CD, we need to make the point D as the shortest distance from the inner surface. To find the point G, draw arc with EH as radius from points E and C. For both E and C the distance is same from G, where as the point D is much shorter. Take out the material in the portion FGH by machining the surface.

On magnetizing, the field from inner surface will divide from the portion left of F in to two. One portion will move towards A and other will move towards C. The field density in the surface BC is much lower compared to CDE. Though point E is having high density, the point physically lies at much lower place for it to react with stator field. However, the point CD lies at much higher place and has the maximum density too. This field will react with outer magnets field and deflect on the direction of lower field density. The lower field density, especially the reacting portion of the field lies on DE and also at lower portion. However, the portion BC, which is at high point, has low density. So the density difference between the sides left of D and right of D decides the rotation.

The field has the tendency to shift the rotor axially. Hence, it is required to arrest the motion along the axis using thrust bearing. The arc decides the depth of point E, and height of the segment. Hence, the radius of the inner and outer surface of the rotor decides the number of segments. By adhering to a specific proportion, it brings in a constraint on the size and the power output of the motor. Initially I decided to have the slot FGH centered along the axis OF with point G lies on the axis. Moving the slot to the right gave the opportunity to shift the peak field to desired location. More advances were made in subsequent designs. For now I would consider this is my base design.

Some Notable Points:

We are now able to move the peak field to desired location by moving the cut in the inner surface. Designer decides the height of the magnet. However, the height decides the arc and the depth of valley point. Then radius of the rotor decides the number of poles. For maintaining proper field distribution on the stator, the height of the stator has to be same as the minimum distance GC. If the height is small then field will flow from C to outer of the stator rather than going from C to G. This would lock the rotor. Care should be taken while deciding the height of the stator magnet. The thickness of the stator and rotor are to be maintained same and should be aligned perfectly.

The peak field along GD lies almost along the axis OD, which is also the axis of the stator field. It would be advantageous, if we have the field of rotor at an inclination to the stator field to get maximum output. I would prefer to have the field direction along DJ. In that way this construction is little inefficient. Still it is a worthy model considering the easiness of construction.

With this as the basic model, improvement have been done by altering and changing some of the parts/concepts to get maximum out of it. Since the Peak point on the inner surface, that is the point G decided the angular inclination of the magnetic field direction, then moving the slot further towards J will change the angle of the field. However, this poses a little problem in retaining the desired field distribution.

Similarly, the necessity for retaining the portion of BC has to be reconsidered, as existence of this portion will give out a low field density, which will react with the outer magnet field and bring down efficiency. In the subsequent design, both these major problem of this design were addressed.

Magnodrive-SS

(Single Stage)

Reference Drawing: MD-SS-001

The drawing MD-SS-001 shows the construction method of a single stage MagnoDrive. The MagnoDrive has two parts. One is the stator assembly and the other is the rotor assembly. As the rotor follows a specific ratio for the placement of segments, the rotor sizes are controlled by the choice of material, shape of the magnet and construction method. So, we always end up in maintaining some minimum size of rotor. I would prefer to have a spline shaft for the rotor mounting. As the axial force will be dominant, the axial thrust will have to be arrested by using thrust bearings. However, the rotor shaft will be supported on the casing, using a ball bearing.

Since we don't have much option on the rotor side for controlling the output, the only way is to control by manipulating the stator. I suggest having the stator cylindrical magnet to be split in to two semi circular cylindrical magnets. By moving the stator magnets towards the rotor, it is possible to have a controlled reaction. Make sure the stator and rotor magnets are perfectly aligned. Without proper control, it will be difficult to implement this drive for any practical solution. In the drawing, I suggested using a mechanical system with studs and support, with which we will be able to move the magnets up and down. Turning the hand wheel turns the gear connected to it, consequently driving the pinions. This pinions turns the studs. These studs, apart from supporting the magnet, will also move the magnet up and down, as it has a right hand and left hand threads on it. This entire mechanism can be replaced by either an electromechanical system or a hydraulic system. Since, the application decides the control system, I leave the choice of control system and the casing to the design engineer.

Magnodrive-SCS

(Semi Circular Segment)

Reference Drawing: MD-SCS-001, MD-SCS-002

MagnoDrive-SCS uses a semi circular segment magnets in its rotor assembly. The Drawing MD-SCS-001 shows the field distribution in a semi circular segment magnet. In the drawing, in the absence of the inner slot DFE, the magnetic field entering section OA will bend towards H, and the field in the section OB will bend towards J. The peak fields will be at about 45 degrees to the axis ON. This will be equally divided on both sides of axis ON. To move the peak to desired location, we have to reduce the distance between top and bottom surface. I achieved this by cutting the semi circular slot close to one edge on one side B. Now from point S, the point R and V lie at the same distance. This point S is the longest distance from the inner surface. Now the peak should lie, somewhere half way between A and S. similarly, the peak field on the right side should lie fairly close to S. However, this peak G will be larger compared to the peak at H because, the field in the section BR moves towards G and AR moves towards H. Note that the AR has become small and BR is larger. The field center at the bottom surface had moved to R from O.

The depth of cut DVFE decides the point S, moving the slot towards O will also help to move the point S to left. However, Our aim is to get maximum angular inclination of the exiting field at G to that of the stator field. The stator field is at angle KJ and external field out of the segment at G will be GF. This creates an intersection angle. Now the SNGJ is high field density compared to the field right of J. This creates a field density difference at the peak reaction point GJ. The angle of intersection between the axis GF and JK is supportive to push the magnet to right with huge force. At the same time, as much physically low you maintain the field density at AHS, so low is the field reaction with stator magnetic field. Hence, it reduces the losses. The depth of cut and size of the magnets are to be decided based on the choice of magnetic material. Different magnetic material produces different field density, resulting in different location of maximum field. Hence, a common solution can't be given. This requires an extensive research with various materials.

The drawing MD-SCS-002 shows the construction method of the MagnoDrive with semi circular segment magnets. This specifically shows a six poles construction of the motor. If you consider the height of the magnet to be 25 mm, then the field emanating from the top surface will go through the sides to reach the bottom of the pole. So a clearance or a gap of 8 mm is given between the magnets bottom surface and the rotor surface. This is represented by circle ‘b’. Circle ‘c’ is the circle that actually supports the segments at its centers. The width of the rotor at this point is about 10 mm. Circle ‘a’ is the innermost surface of the rotor. The circle ‘c’ is divided equally to build 6 segments poles as shown in the figure. The circle ‘d’ is decided after giving sufficient air gap between the peak points of the segment and the stator inner surface. The slot DFEC is decided such that the peak field is obtained at G. This depends on the choice of the material, size and geometry of the surface and slot.

The size of the shaft, that is innermost surface is decided as 25 mm radius then the circle ‘c’ is approximately 38 mm. The maximum segment height that we can get will be limited to 20 mm. Consequently the maximum height of the stator magnet can be 20 mm only. The height decides the width of the pole as it is twice the height. The dimension becomes critical and follows the specific circle geometry. However, these dimensions are samples, only to explain how it follows the proportion. These can be linearly scaled to make big size of motors. If you want to make a 10 pole instead of a 6 pole, the height of the magnet has to be reduced or the diameters are to be increased. Similarly, there is no such rule, as we should only have odd number of poles or even number of poles. The choice of polarity of the magnetic pole is also insignificant. You may either choose to have South Pole facing South Pole or North Pole facing North Pole. Please make sure, you choose proper polarity of the magnetic poles.

Magnodrive-US

(Umbrella Segment)

### Reference Drawing: MD-US-001, MD-US-002, MD-US-003, MD-US-004

The MagnoDrive-US uses the Umbrella Segment magnets to build the rotor assembly. The Drawing MD-US-001 shows the Field distribution of the Umbrella Segment. This shape was derived from the Semi Circular Segment. As we moved the slot to the far end of one side of the segment in the case of semi circular segment magnet, I felt there is no harm in taking out entire portion, as the right of the slot doesn't really serve any purpose any way. Whereas, removing this gives more control on the depth of the slot, there by control on the position of the peak field. In the drawing, the position of the minimum field ‘P’ moves to ‘N’ and then to “M” when the depth of cut moves from ‘DQE’ to DRE’ then to ‘DKE’. The ‘DKE’ is a semi circle drawn, keeping the DE as the diameter. Accordingly, the peak field moved from PGE to its left towards P. This construct gives very high control there by we must be able to fix the peak field on the axis OT at T. This T is the most elevated point and also the closest point to the stator magnet. The Field external to the magnet at this peak field will be along the axis TJ. This TJ is a maximum angle that we get. Considering our expectations, this should be the most advantageous and a flexible construction.

The drawing MD-US-002 shows the construction of the Umbrella segment rotor MagnoDrive with 6 poles. The Circle ‘c’ is the outer support of the rotor, over which the umbrella segment magnets are mounted. The circle ‘d’ is the virtual circle connecting all the tips of the upper most point of the South Pole. The CF is 10 mm, which is half of the segment height of 20 mm. The drawing shows an arc DC drawn with 10 mm radius from point F. The point F is arrived by drawing an arc from point ‘C’ with 10 mm radius, and meets the outer of the circle ‘c’. The field is expected to peak at G, which is the closest point to the outer magnet. The stator magnet can be up to 10 mm thick. This is a constraint, brought by the distance between the circles ‘d’ and ‘e’. If you exceed this, then the field from the stator North Pole will flow towards the point C instead of to its own south pole. This would result in locking the rotor.

The distance HK is slightly more than 10 mm. This displacement is got by natural placement of the poles. However, the field in the section AB is not expected to react with stator. So it would be a good idea to bring down this field by moving the Point C closer to adjoining pole.

The drawing MD-US-003 shows the effect of the placement of the segment. The segment ABCD and LMNQ are the original positions of the segments. The field on the portion ML will be much elevated. When the segment ABCD is moved to new place FGHJ, then the nearness of the point H to the section LM would draw the entire field in that section towards it. This would eventually cut the reaction of the field in section LM with the stator magnetic field. Apart from that, it reclaims a distance of CH. 6 such gaps will help us to place an additional segment, making the rotor seven pole construction instead of a six pole motor. This additional segment will eventually increase the power output apart from reducing the losses.

The drawing MD-US-004 shows the Seven Segment squeezed construction of the Umbrella segment rotor MagnoDrive. The rotor inner, and outer diameters are maintained same as that of a six Pole motor. Only the adjustment of the spacing between the segments enables to accommodate an additional Pole. Other conditions applicable to semi circular segment construction are applicable to this construction too.

Magnodrive-CS

(Crescent Segment)

Reference Drawings: MD-CS-001, MD-CS-002, MD-CS-003, MD-CS-004, MD-CS-005

The MagnoDrive-CS uses the Crescent Segment magnets for its rotor assembly. While going through various types of segments, the semi circular segment gave a significant change in distribution, which divides equally on both sides. Then I thought of tilting the segment such that the one side of the field is elevated and other side is left at a lower position with respect to the stator. This concept emerged as a new design. The field distribution of the magnet is shown in the drawing MD-CS-001. The field is divided equally on both sides. If you place the Stator magnet along xx′yy′, then the peak field F will react, where as the field E will lie physically at a much lower place and refrained from reaction. Another good point to note here is that, the field exiting the magnet will be almost parallel to centerline CD. Hence, tilting the magnet will also tilt the field inclination to the stator field. This is another apt method to construct MagnoDrive where, we meet both the desired conditions. The mounting is purely a mechanical engineers work and can easily be dealt with.

The drawing MD-CS-002 shows the influence of the segment placement and relationship between the segment distance from the center and the peak point drift. If you go along the axis Oa3B1, then how far you place the segment, the closest point remain the same at B1. However, if you move the segment along the axis a2a3 then the peak or closest point to the outer ring would vary significantly. Depending on the type of material you choose, the field density will vary and hence the location of the peak field. Depending on where the peak field is, we may end up choosing a specific radius for the rotor outer surface, over which we will mount the segments. Depending on the tilt, the right most corner will also get elevated. This would draw the field from the stator towards it and lock the rotor. Care should be taken to arrive at an optimum angle and the arc. The dimensions become critical in the crescent segment construction. This follows the circle geometry precisely.

Drawing MD-CS-003 shows the mounting of the Crescent Segment over a rotor surface. This drawing is to show the three-dimensional view of the mounted segment.

The drawing MD-CS-004 shows the construction method of the 6 Pole rotor assembly MagnoDrive. I assumed that the South Pole (bottom surface of the magnet segment) peak point that is the point C should lie much lower than half the distance between the stator and rotor cylindrical surfaces. The peak fields will lie along DF and DE. In the present drawing, the F is at lower point compared to the peak point G. However, this point F can be moved to lie along the axis ODG by moving and tilting the magnet physically. The angle at intersection between stator and rotor fields will be the angle between OB and BD. The geometry has to be very well maintained and it follows specific ratios. Any change to the geometry changes the alignment and distribution. Hence, these constructions are to be dealt on case-to-case basis. The JHK section of the adjoining segment lies at almost same distance as the distance between the point C and rotor surface. In this construction the field distribution of the rotor segment are undisturbed because of the displacement. However, depending on the strength of the magnet, the peak field at the point E may react with stator field. If so, it would result in loss of power. To avoid this, the point E has to be tilted to a much lower position by elevating point C.

Another way of handling the above said problem is shown in the drawing MD-CS-005. Long segment magnets are placed and part of the segments bottom (which is south pole) over laps on the adjoining segment with sufficient clearance between them. In the drawing the field on the section BJC will tend to flow towards K rather than reaching BEG. This is a very welcome situation, as this would suppress the field in section BJC from actively interfering with the stator field. This would draw all the undesired reaction towards it. At the same time the desired section FH lies on the most elevated place. This would be the most preferable construction. To do this, we have to follow a rotor to stator ratios as 1R:3R:5R:10R. Unlike other constructions, the support here is at one edge. Hence, this requires special support to hold the magnets on place, at the same time the support should not interfere with the field distribution. Not only the top surface of the segment, the arc of the bottom surface is also important as this will decide the thickness of the segment and the location of the peak field density. Circle geometry plays a very important role in this construction.

All the other conditions with respect to the single stage, Multi stage and electric powered MagnoDrive construction techniques are applicable to this too. This construction is linearly scalable. As the size explodes, the geometric ratios may also vary.

Magnodrive-EP

(Electric Powered)

Reference Drawing: MD-EP-001

The drawing MD-EP-001 shows the construction of electric powered MagnoDrive. In this construction the permanent magnets are substituted with electro magnet. All the other constructional details, field distribution and reactions are expected to be same as in the permanent magnet construction. In the case of electro magnet, it is suppose to draw the current only for the excitation of the magnets and not for the power output. That means, it should draw only magnetizing current and reaction is expected to be a natural magnetic reaction. It is expected to draw very low current and produce much higher output. Practically, it should be a regenerative motor. As we have mastered the electrical control systems, it is easy to control the excitation current and voltage fed to the motor. The stator magnet will be a simple cylindrical magnet over which, the coils are wound on the circumference. This is a simple circular winding.

The rotor magnets can also use an electromagnet instead of a permanent magnet. The Drawing shows crescent segment magnets. The base segment is taken with magnetic core and coils are wound over the crescent segment piece. To maintain the field distribution of various shapes, the coils can be encapsulated by magnetic material with that shape. The power is fed to this magnet via sliprings. A steady DC power is fed to the magnet. This Electric powered MagnoDrive will be a good solution for all the present day motors to reduce the power consumption with good automated control system. Power connections are extended to the case. The connection post on the case will provide terminals to connect external supply.

Magnodrive-MS

(Multi Stage)

Reference Drawing: MD-MS-001

In the construction of the MagnoDrive, the size of the magnets controls the field distribution. Especially the height and thickness has to be maintained to get desired distribution. This imposes some limitation on the design, consequently the power output. Human needs can't be met with such limitation. The solution to meet the higher power demand is the multi stage construction. The multistage construction is shown in the drawing MD-MS-001. The basis for multi stage construction is to construct many single stage rotors over the same shaft. Sufficient clearances are to be maintained between the stages to avoid interference of adjoining sections fields. Each stage is isolated and sufficient clearances are maintained by inserting spacers on the shaft. These spacers can also be replaced by support, if you would encounter the problem of sagging of shaft due to weight of the assembly. Apart from this, as in the single stage, the multistage too should have the thrust and support ball bearings. However, the mountings and supports are left to the choice of the mechanical design engineer. Care should be taken to align the stator and rotor magnets. Any misalignment would result in loss of power and consequent problems.

Magnodrive-STC

(Saw Tooth Construction)

Reference Drawing MD-STC-001

From the basic magnetic field distribution characteristics, I expected the field would be uniformly distributed between the North Pole and South Pole as shown in the figure as BCDE. I also expected the field to emanate perpendicular to the surface, uniformly all over the surface. Hence, I designed a saw tooth cut on the outer surface of the rotor, keeping the inner surface of the rotor as smooth cylindrical surface. To make it as a motor, I used an outer cylindrical magnet for the stator with pole facing the rotor and the rotor outer surface is same.

When the rotor was constructed, the field was high at the lowest point of the rotor surface (the valley point of the saw tooth) at FGHJ. This was totally opposite to my expectation where, I wanted to have maximum field at the peak point followed by a low field in the lower portion of the inclined surface. At the least, if the field would have been uniform in the inclined surface, that would have helped.

Surprisingly I noticed that, the field density directly below the valley point on the inner surface of the rotor at FJ was high compared to the adjoining places EF directly below the peak points. This prompted me that I should reverse the cutting. From this failure, I learnt that, when the medium is same (external to the magnet), the distance between the poles decided the field density and the distribution. Hence I decided to cut the slot on inner surface and manipulate the outer surface to meet my requirement. However, this construction method failed to meet my minimum requirement. Hence it was abandoned. I claim the following as my invention:

1. Using the shapes of the magnet as shown in the Arc construction method either in a rotor or a stator assembly of any dimension with one or many poles and making a drive or a motor using either permanent magnet or an electro magnet.

2. Using the shape of the magnet as in the semicircular segment construction method either in a rotor or a stator assembly of any dimension with one or many poles and making a drive or a motor using permanent magnet or an electromagnet.

3. Using the shape of the magnet as shown in the umbrella segment construction method either in a rotor or a stator assembly of any dimension with one or many poles and making a drive or a motor using either a permanent magnet or an electromagnet.

4. Using the shape of the magnet as shown in the crescent segment construction method either in a rotor or in a stator assembly of any dimension with one or many poles and making a drive or a motor using either permanent magnet or an electromagnet.

5. Method of tilting the magnet to get desired reaction angle between the stator magnetic field and the magnetic field of rotor assembly magnetic poles and constructing a rotor assembly to produce the reaction there by constructing a motor or a power drive.

6. Method of assembling multiple rotor assemblies of either standard Magnodrive rotor or other models of Magnodrive rotor assemblies like, Semicircular segment, or umbrella segment or crescent segment construction, on single shaft either with or without support in between stages, to increase the power output and constructing a multi stage assembly.

7. The method of changing the field distribution of a magnet on one surface by modifying the surface of the opposite pole, for creating drive or motor of any sort using either permanent magnets or electromagnets.

8. Changing the shape of the surface to lower the physical level of the field and to control the reaction, there by making a motor or a power drive using permanent magnet or electro magnet.

9. Method of using semi cylindrical magnets to move close and away to control the magnetic field reaction and there by constructing a motor or a power drive.
